(19) United States
(12) Patent Application Publication
(10) Pub. No.: US 2007/0085011 A1
(43) Pub. Date: Apr. 19, 2007

(54) Method and imaging system for generation of a scintigraphic exposure of a patient

(76) Inventor: Dieter Ritter, Furth (DE)

Correspondence Address: SCHIFF HARDIN, LLP;PATENT DEPARTMENT, 6600 SEARS TOWER, CHICAGO, IL, 60606-6473, US

(21) Appl. No.: 11/518,068

(22) Filed: Sep. 8, 2006

(30) Foreign Application Priority Data
Sep. 9, 2005 (DE) 10 2005 043 023.6

(51) Int. Cl. G01T 1/166; G01N 23/04; G21K 1/02

(52) U.S. Cl. 250/363.05; 250/363.1; 378/63

(57) ABSTRACT

In a method for generation of a scintigraphic exposure of a patient, a contrast agent emitting gamma quanta is administered to the patient, and a parallel collimator is arranged between the patient and a planar image detector of an x-ray system. Image data are generated in the planar image detector by gamma quanta passing through the collimator and irradiating the planar image detector. The image data are read out from the planar image detector as a scintigraphic exposure. An imaging system for generation of a scintigraphic exposure of a patient has an x-ray system with a planar image detector supplying image data and a parallel collimator for gamma radiation that can be arranged between the patient and the planar image detector.

### BACKGROUND OF THE INVENTION

1. Field of the Invention

The present invention concerns a method and an imaging system for generation of a scintigraphic exposure of a patient.

2. Description of the Prior Art

Imaging methods and imaging systems are increasingly gaining importance in everyday medical life. The focal point in recent times has primarily been on 3D imaging systems, which supply three-dimensional image data sets or reconstruction volumes of a spatial region of interest of a patient or in a patient.

For example, 3D x-ray C-arms are known that are equipped with a planar image detector instead of a conventional x-ray image intensifier. While conventional x-ray image intensifiers offer no or only insufficient soft tissue resolution, i.e. they can essentially show only bone structures in the patient, planar image detectors offer a sufficient soft tissue resolution in order to also resolve or, respectively, be able to show patient tissues and organs at sufficient contrast relative to one another.

Such 3D x-ray C-arms are equipped to acquire up to multiple hundreds of individual images of the patient by x-ray radioscopy with an orbital or angulation travel around a patient located in the isocenter of the C-arm. For this purpose, the C-arm is usually angularly or orbitally moved by motors through an angle range of at least 180°. The several hundred x-ray images of the patient are thus acquired from respectively different directions and stored as an image sequence or image data set.

The individual images are combined using a suitable reconstruction algorithm into a 3D reconstruction volume as a map (image) of the patient or a part of the patient.

For the reconstruction algorithm to produce an accurate result, it is important for the C-arm to have been calibrated (for example at the manufacturer, at the time of installation, or in a regular servicing) in order for the algorithm to be able to precisely “know” the acquisition geometry of every individual image from the image data set. “Position” means positions or relative positions of the detector, the x-ray tube and the isocenter with respect to one another as to their separations and angles.

Displacements and deformations of the C-arm are ideally already taken into account and are stored as well in what are known as a projection matrices. An example of a known reconstruction algorithm is the back-projection method.

Such 3D x-ray C-arms are primarily used for intra-operative application, i.e. during an interventional procedure or a treatment of a patient.

Moreover, it is known to use such acquired image data together with other image data which were acquired at an earlier point in time, namely in advance of the treatment of the same patient; called pre-op image data. These are typically image data stemming from radiology which, for example, were generated some time before the treatment for the purpose of making a diagnosis.

In order to achieve a comparison between the two image data acquired at different times, it may be necessary to anatomically adapt the earlier-acquired image data to the current patient position on the operating table, or to associate the previously-acquired image data in the currently applicable coordinate system of the treatment space with spatial accuracy. This is known as a registration of the image data. This is often accomplished using patient markers, tracking systems or navigation systems, or the like. Such an adaptation compensates deformations of organs due to various patient positions (such as prone or dorsal positions), for example.

The pre-op image data originating from radiology often stem from positron emission tomography (PET) or single photon emission CT (SPECT). The linking or fusing of such previously-acquired image data with x-ray CT image data acquired during the treatment is used for imaging changing anatomy. For example, functional imaging originating from nuclear medicine shows the shape, expansion (dimensions) or size of a tumor clearly or in high contrast. Together with static anatomical (x-ray) imaging, its position in the patient can then be localized very precisely.

Nuclear images (thus PET or SPECT image data) acquired, for example, a few days before the treatment or operation have previously been spatially associated (i.e. fused) with the x-ray CT image data using simple registration algorithms. The registration algorithms are extremely imprecise and therefore supply only approximate spatial information relative to the functional imaging.

The basis of each functional imaging modality cited above is the acquisition of a scintigraphic exposure. A type of detector known as a gamma camera is used for this purpose. For obtaining a scintigraphic exposure, a contrast agent that is a gamma ray source is administered to the patient. The gamma rays or gamma quanta exhibit no preferred direction like x-rays; rather, they radiate omnidirectionally from the inside of the patient. The gamma cameras known for scintigraphic exposure are special devices highly developed for this purpose.

An example of a gamma camera according to the prior art is shown in FIG. 3. The gamma camera 50 has a monocrystal (for example thallium-doped sodium iodide) as a scintillator 52. A planar array formed by photomultipliers 56 is arranged on the side facing away from the patient 54. Due to the omnidirectional gamma radiation, a parallel collimator 58 is additionally arranged in front of the scintillation crystal, between the patient 54 and the scintillator 52. A wide variety of collimator types exist for various applications. Only gamma rays 60 (of which one is exemplarily shown) that propagate perpendicular to the plane of the collimator 58 can pass through the collimator 58.

A result known as parallel imaging therefore ensues due to the collimator, meaning that only gamma quanta or gamma rays from the patient 54 which are emitted parallel to the collimator transmission direction reach the scintillator 52. The gamma quanta are thus directionally filtered. Each gamma quantum triggers an avalanche 62 of photons in the scintillator 52, such that a number of the photomultipliers 56 situated behind the scintillator 52 each respond upon the incidence of a gamma quantum in the scintillator 52. The precise location of the incident gamma quantum is subsequently evaluated in an evaluation unit 64 by interpolation of the photomultipliers 56 situated around this location.

The problem of scatter radiation also occurs, meaning secondary radiation which is caused by primary gamma quanta that are initially emitted from the patient in directions non-parallel to the collimator transmission direction, that are scattered by body tissue, bones or the like in the patient and thus ultimately change their direction into a direction parallel to the collimator transmission direction and can pass through the collimator, and thus reach and strike the scintillator. Due to the scattering in the patient, however, these secondary gamma quanta have a lower energy than the primary gamma quanta originating directly from a decay, and which were already emitted parallel to the collimator transmission direction. Due to the purely monochromatic gamma radiation of the contrast agent the primary quanta have identical energy so the scatter radiation can be detected in the gamma camera by energy discrimination in a multi-channel analyzer. Secondary events (thus due to scatter radiation) in the scintillator thus generate a weaker light pulse.

A scintillator crystal exhibits a size, for example, of 60×50 cm² at 10 mm thickness and is associated with fifty hexagonally-arranged photomultipliers. The entire achievable spatial resolution of the gamma camera is a few millimeters, together with a collimator perhaps in a range below 10 mm. For energy discrimination in a multi-channel analyzer, thus the detection of scatter radiation, energy decays (resolutions) of ΔE/E₀=10% can be achieved with achievable count rates of approximately 250,000 pulses, i.e. gamma quanta per second.

The image data so acquired and read out from the scintillator or the photomultipliers supply a single scintigraphic exposure of the patient. By suitable movement of the gamma camera orbitally or angularly around the patient similar to as in x-ray CT, several hundreds of scintigraphic exposures can likewise be acquired and a 3D reconstruction can be calculated with a suitable back-projection. This occurs in a SPECT scan. A typical duration for a SPECT scan is 20 min. In contrast to x-ray CT, due to the parallel projection a back-projection method specifically designed for parallel projection must naturally be used for the back-projection.

PET is not discussed in detail herein because in this modality gamma decay is detected in a detector ring in the form of a 180° flash. Special PET tomography systems are necessary for this.

The known methods and devices for generation of a SPECT 3D reconstruction volume are all expensive and elaborate due to the complicated gamma cameras and stand in stark contrast to relatively cost-effective solutions available today in the form of a 3D x-ray C-arm for generation of a three-dimensional CT x-ray reconstruction volume.

Apparatuses exist that are a combination of x-ray CT and SPECT, but such combination apparatuses are even more complicated in comparison to conventional SPECT apparatuses since these additionally include a complete or nearly complete x-ray C-arm for x-ray CT in addition to the gamma camera. Such combination systems are also extremely complicated and expensive.

### SUMMARY OF THE INVENTION

An object of the present invention is to provide a method and imaging system for generation of a scintigraphic exposure of a patient.

With regard to the method, this object is achieved by a method for generation of a scintigraphic exposure of a patient to whom a contrast agent that emits gamma quanta is administered. A parallel collimator is arranged between the patient and a planar image detector of the x-ray system that supplied image data. The image data are generated in the planar image detector by gamma quanta passing the collimator and irradiating the planar image detector, and the image data are read out from the planar image detector as a scintigraphic exposure.

The invention is based on the insight that many planar image detectors used for conventional x-ray imaging can be used as gamma ray detectors for a specific gamma energy range and thus can be used as a type of gamma camera for scintigraphic exposures. The planar image detector has a scintillator layer originally designed for detection of x-ray quanta, but can also detect gamma quanta of suitable energy. The planar image detector also has a layer of amorphous silicon that detects the photons caused by the x-ray quanta or gamma quanta in the scintillator layer.

The invention is furthermore based on the fact that a metabolic preparation marked with unstable nuclides is normally injected into patients for nuclear imaging, the metabolic preparation typically including the technetium isotope TC-99 m. This has a half-life of 6 hours, and the emitted gamma quanta have an energy of 140 keV.

The spectral sensitivity of a conventional planar image detector (in the example the PaxScan 4030 of the company Varian) is shown in FIG. 2 of the drawings. FIG. 2 shows the energy of incident particles in keV on the abscissa and the absorption effectiveness of the planar image detector (normalized to a standard value) on the ordinate. A first curve 70 shows the spectral sensitivity for the scintillator material Csl; a second curve correspondingly applies for Gs₂O₂S. Primarily for the scintillator made of cesium iodide (thus the curve 70) it can be seen that the spectral sensitivity of the planar image detector is insignificant at the gamma energy of 140 keV, namely lies approximately 10% below the minimal sensitivity to typical x-ray radiation. Typical x-ray radiation lies in a range from 40 to 120 keV. Such a planar image detector of a conventional x-ray system is thus in principle suitable for detection of gamma quanta.

In the inventive method, as in the prior art, the administration of gamma quanta-emitting contrast agent to the patient is also required. Following the above insight, the gamma quanta are then inventively detected by a planar image detector of a conventional x-ray apparatus. Since, as explained above, the gamma radiation is omnidirectional (in contrast to the directed x-ray radiation), according to the invention a parallel collimator is arranged between the patient and the planar image detector. This has the effect of filtering the omnidirectional gamma radiation in the sense of a parallel acquisition (as explained above) and thus, in other words, of charging the planar image detector with directed gamma rays. The x-ray image detector is thus operated as a type of gamma camera for acquisition of a parallel-projected image of the patient.

The image data generated in the planar image detector now correspond not to an x-ray image but rather to a scintigraphic exposure, since they were generated by the gamma quanta emitted by the contrast agent instead of by x-ray quanta. According to the invention, the image data are therefore read out from the planar image detector as a scintigraphic exposure.

In contrast to a conventional gamma camera, a further effect results from the use of the planar image detector: since the scintillator layer of the planar image detector is not a monocrystal, but is formed of amorphous silicon, and since the scintillator is needle-like, an incident gamma quantum does not trigger a photon avalanche as described above. Only the light sensor associated with the respective image point of the image data of the planar image detector is therefore activated and supplies a discrete, spatially narrowly limited digital output signal. The spatial resolution of the planar image detector of the x-ray system operated as a gamma camera is thereby increased relative to a gamma camera, or corresponds to the spatial resolution of an x-ray image acquired with the planar detector. The spatial resolution in the inventive imaging system is therewith only determined by the collimator type or, respectively, predetermined by this.

Due to the scintillator layer of the planar image detector that is not specially adapted for gamma radiation, the scintillator of the aforementioned PaxScan has only 45% of the light yield relative to a conventional gamma camera, and has further physical parameters that are not ideal for gamma imaging, namely a lower absorption rate in the x-ray planar image detector in a gamma camera.

Nevertheless, the quality of the imaging is sufficient to generate scintillator exposures, at least for the non-diagnostic operation. A high-quality exposure with a special gamma camera designed for this purpose such as, for example, in an expensive standard SPECT cannot be replaced for making a precise diagnosis.

An x-ray system that is already suitable for x-rays, for example a low-cost x-ray C-arm, is significantly expanded by the invention in terms of its functionality without noteworthy technical expansions, namely simply by the insertion of a gamma radiation collimator.

The collimator between the patient and the planar image detector can be removed before and/or after the generation of the scintigraphic exposure. The patient then can be exposed with x-rays emitted toward the planar image detector and the image data so generated can be read out from the planar image detector as an x-ray exposure of the patient.

Upon removal of the collimator, the x-ray system thus can be operated in a conventional x-ray mode before and/or after a scintigraphic acquisition. Anatomical x-ray imaging and functional scintigraphic imaging thus are combined in a single, normally mobile apparatus. The use of the single system for both types of exposures avoids the interactive, imprecise, error-plagued and time-consuming registration between scintigraphic and x-ray exposure given the use of two separate apparatuses.

The essentially identical or similar imaging matrices for the x-ray and scintigraphic exposures in particular apply when the x-ray system is not moved in the interim. If the patient is not moved, both imaging methods are thus implemented given an unchanged geometry and thus the images can be directly mapped to one another or set in direct geometric relation to one another.

Activity centers displayed by the functional imaging thus are mapped exactly to the point at which the patient is located in the current situation, thus exactly at the same location as in the x-ray exposure acquired before or subsequently. The combined functional and anatomical imaging is thus particularly, cost-effectively supportive in minimally-invasive procedures.

The x-ray exposure and the scintigraphic exposure can be acquired in the same viewing direction and be fused into a combination image. It is merely to be taken into account that different projection matrices apply for both methods (namely the acquisition of x-ray and scintigraphic exposures) due to the diverging primary radiation in the x-ray case and the omnidirectional radiation “forced” to be parallel by the collimator in the scintigraphic case.

An attenuation factor caused by the patient for the gamma quanta in the generation of the scintigraphic exposure can be determined using the x-ray exposure, and the scintigraphic exposure can be corrected using the attenuation factor.

Since the x-ray exposure offers a certain soft tissue resolution (in particular given use of a planar image detector), this supplies information about, for example, the tissue and bone density distribution in the patient. These known density distributions in the x-ray image are then used to calculate attenuation factors for gamma quanta that penetrate exactly this tissue or this bone on the path from their point of generation to the incidence on the planar image detector. Due to the weighting of the scintigraphic image with a corresponding inverse attenuation factor, the original radiation present at the site of the emission of the gamma quanta can be concluded and thus the scintigraphic exposure can be corrected, for example with regard to its brightness or coloring.

A scatter radiation correction of the scintigraphic exposure can also be implemented using the x-ray exposure. As explained above, the gamma camera offers a direct possibility for separation of the scatter ray portion in the scintigraphic image. By contrast, the planar image detector does not offer this possibility. An energy measurement as in the gamma camera is not directly possible in the planar image detector.

The scatter ray problem does not occur in x-ray imaging since, due to the air gap method, the largest part of the scatter radiation is radiated past the planar image detector, but the scatter radiation significantly contributes to the imaging in the inventive scintigraphic acquisition. As explained above, however, by the combined acquisition of scintigraphic and x-ray images conclusions can be made about the anatomical structure or density distribution in the patient using the x-ray exposure. In addition to the aforementioned attenuation correction, a gamma scatter ray reduction in the scintigraphic exposure also can be implemented by suitable iterative algorithms. The gamma scatter ray reduction can lead, for instance, to the same image improvement as the energy discrimination of the gamma camera.

If the x-ray system is a 3D x-ray C-arm system, a number of scintigraphic exposures of the patient can be acquired from various directions by moving the x-ray system and a 3D SPECT reconstruction volume can be determined therefrom. Since the x-ray C-arm and in particular its planar image detector are already provided or designed for orbital (most also for angular) movement, by the use of the 3D x-ray C-arm a series of scintillator exposures can be produced particularly simply, and from this a 3D reconstruction volume for functional imaging can be reconstructed as in the known reconstruction conventional for SPECT. In contrast to the x-ray acquisition, the parallel back-projection can be used in order to account for the varying acquisition geometry of the planar image detector in the gamma mode, with the collimator between the patient and the planar image detector.

With a low-cost x-ray C-arm it is possible to implement combined SPECT and C-arm CT imaging in the same normal position of the C-arm merely by introduction of the collimator, without requiring an elaborate registration between both image data sets. The corrections cited above due to attenuation factors etc. also contribute further to the image improvement.

For example, a computed tomography scan can be implemented given a 180° rotation of the C-arm to a first or rotation position, and a SPECT can be implemented upon return travel of the C-arm into the starting position (i.e. a back and forth rotation). Time and expenditure of the generation of a combined functional and anatomical 3D image data set is drastically reduced, as well as the costs.

With regard to the apparatus, the above object is achieved by an imaging system for generation of a scintigraphic exposure of a patient with an x-ray system that has a planar image detector supplying image data and with a parallel gamma radiation collimator that can be arranged between the patient and the planar image detector.

The apparatus achieved the same advantages discussed in detail above in connection with the inventive method.

As mentioned, the planar image detector can have a scintillator layer made of cesium iodide. This likewise leads to the advantages cited above with regard to the sensitivity to gamma quanta relative to many other materials.

As also mentioned, the x-ray system can be a 3D x-ray C-arm system with the cited advantages.

For easy and fast mounting and dismounting of the parallel collimator, a frame for selective incorporation of the collimator can be arranged on the planar image detector. Bu a disconnectable mechanical execution connection of the collimator in or to the frame, reproducible scintigraphic exposures can be made with one and the same x-ray C-arm even when the parallel collimator is removed or reinserted multiple times in-between. It is ensured that the collimator is reproducibly remounted at one and the same point after it was removed. The scintigraphic imaging thus always ensues again in the same manner and supplies comparable results.

### DESCRIPTION OF THE DRAWINGS

FIG. 1 shows an x-ray C-arm fitted for acquisition of scintigraphic exposures in accordance with the invention, with a patient.

FIG. 2 shows the scintillator sensitivity of the planar image detector of the x-ray C-arm of FIG. 1 dependent on the gamma energy, for two alternative scintillator materials.

FIG. 3 shows a gamma camera for acquisition of a scintigraphic exposure according to the prior art.

### DESCRIPTION OF THE PREFERRED EMBODIMENTS

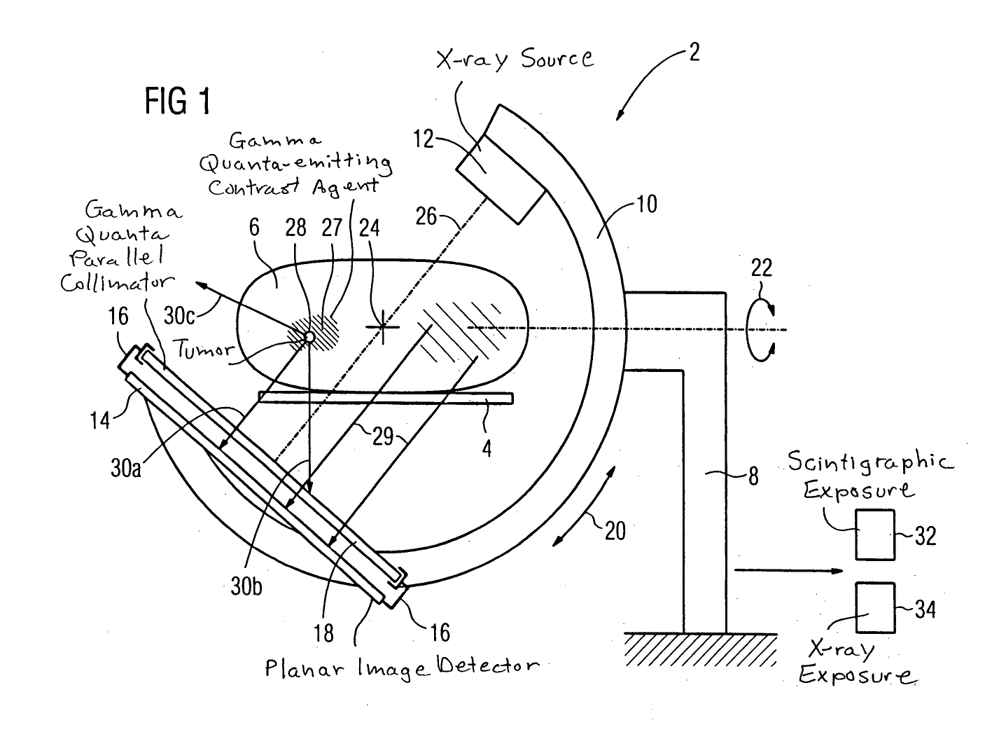

FIG. 1 shows a C-arm 2 for acquisition of x-ray and scintigraphic exposures together with a patient 6 resting on a patient bed 4. The C-arm 2, in a known manner, has the basic components, namely a C-shaped support arm 10 on a base support. An x-ray source 12 and a planar image detector 14 are mounted at the respective ends of the support arm 10.

According to the invention, the C-arm 2 is expanded by a frame 16 attached to the planar image detector 14. In the frame 16, a parallel collimator 18 is held essentially parallel to the planar image detector 14 between the detector 14 and the patient 6.

The C-arm 2 can be moved axially and angularly in a known manner (indicated by the arrows 20 and 22) around an isocenter 24. The central ray 26 of the x-ray system formed by the x-ray source 12 and the planar image detector 14 passes through the isocenter 24 at every orbital and angular panning position of the C-arm 2.

For acquisition of a scintigraphic exposure of the patient 6, a radioactive contrast agent 27 that emits gamma quanta is administered to the patient 6. The contrast agent accumulates at specific locations in the patient 6, for example in the region of a tumor 28. Due to the omnidirectional gamma radiation of the contrast agent 27, gamma rays are thus radiated in multiple directions from the tumor 28. Three directions are represented by the arrows 30a through 30c, as examples

The parallel collimator 18 is designed such that it can pass only gamma rays which strike it substantially parallel to the direction of the central ray 26. This applies, for example, for the gamma quantum or the gamma ray 30a, but not for the gamma ray 30b which strikes at an angle on the parallel collimator 18. The gamma ray 20c which is radiated from the tumor 28 in an entirely different direction from that of the planar image detector 14, and thus does not strike the detector 14.

Due to further gamma rays 29 emitted parallel to the gamma ray 30a or to the central ray 26 from the body of the patient, a parallel imaging is created in the planar image detector 14, i.e. a map of the spatial distribution density of the gamma radiation emitted from the patient 6.

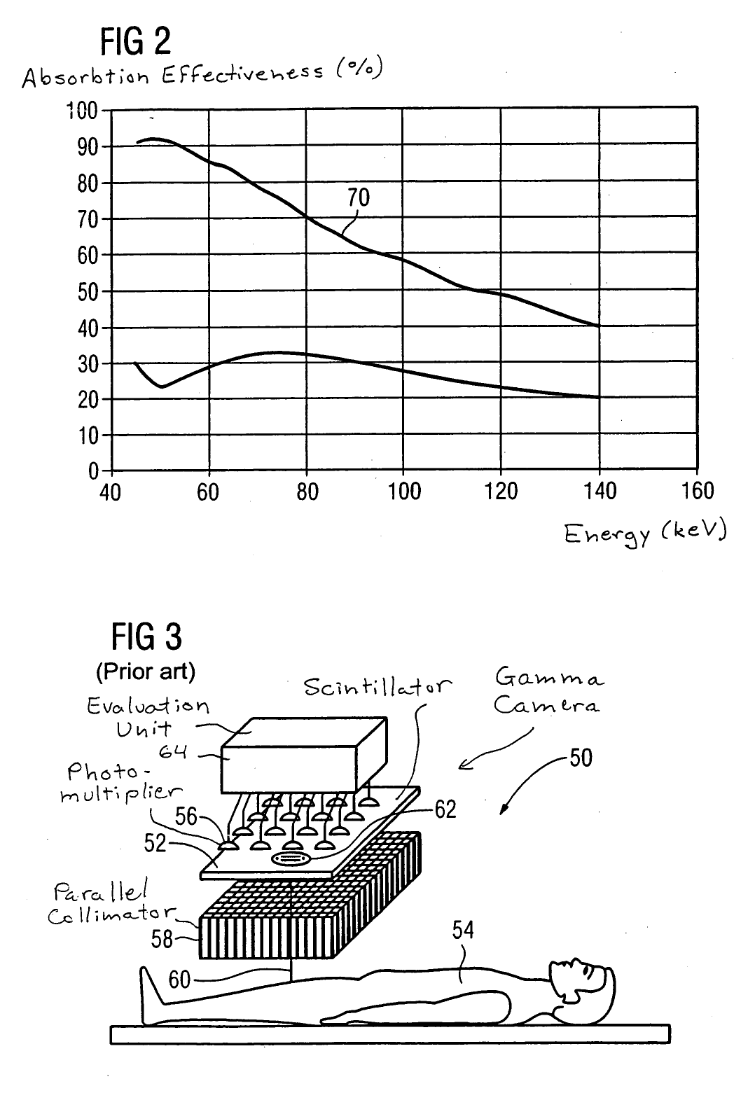

As explained in connection with FIG. 2 and FIG. 3, the gamma quanta 29 or 30a striking the planar image detector 14 generate light signals therein such that, for example, photodiodes (not shown) in the planar image detector 14 are exposed corresponding to the processes in x-ray imaging, such that this planar image detector 14 outputs electronic image data in the form of a scintigraphic image 32.

Alternatively, in FIG. 1 the parallel collimator 18 can be removed from the mounts of the frame 16 or whereupon an imaging system corresponding to a conventional x-ray C-arm (except for the frame 16) remains. This can be used for acquisition of x-ray exposures 34 by operation of the x-ray source 12 and the planar image detector 14 in a conventional manner, which x-ray exposures 34 are read out from the planar image detector 14 as image data as a radiographic exposure of the patient 6.

As explained above, combined x-ray-scintigraphic imagings, as well as corrections to the scintigraphic image 32, are possible, as in the case of CT x-ray and SPECT image data sets, from individual exposures corresponding to the scintigraphic image 32 and the x-ray exposure 34.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for generating a scintigraphic exposure of a subject, comprising the steps of:
administering a gamma quanta-emitting contrast agent to the subject;
placing a gamma radiation parallel collimator between the subject and a planar image detector of an x-ray system, that emits image data;
with said planar image detector of said x-ray system, detecting gamma quanta emitted from the subject that pass through the parallel collimator and reach said planar image detector of said x-ray image system, said planar image detector of said x-ray system generating image data corresponding to the gamma quanta incident thereon; and
reading said image data from said planar image detector of said x-ray system as a scintigraphic exposure.

2. A method as claimed in claim 1 wherein said x-ray system has an x-ray source, and comprising:
removing said gamma radiation parallel collimator from between the subject and the planar image detector of the x-ray system;
irradiating the subject with x-rays from said x-ray source;
detecting x-rays from said x-ray source, attenuated by the subject, with said planar image detector of said x-ray system, said planar image detector of said x-ray system generating further image data corresponding to the x-rays incident thereon; and
reading out said further image data from said planar image detector of said x-ray system as an x-ray exposure, at a time selected form the group consisting of before reading out said image data as said scintigraphic exposure, and after reading out said image data as said scintigraphic exposure.

3. A method as claimed in claim 2 comprising acquiring said scintigraphic exposure and said x-ray exposure from a same viewing direction, and fusing said x-ray exposure and said scintigraphic exposure into a combination image.

4. A method as claimed in claim 2 comprising, from said x-ray exposure, determining an attenuation factor of the subject for said gamma quanta and correcting said scintigraphic exposure using said attenuation factor.

5. A method as claimed in claim 2 comprising determining a scatter ray correction from said x-ray exposure, and correcting said scintigraphic exposure with said scatter ray correction.

6. A method as claimed in claim 1 wherein said x-ray system is a C-arm system having a movable C-arm to which said planar image detector is mounted, and comprising moving said C-arm and said planar image detector through a plurality of different positions and obtaining a scintigraphic exposure from said planar image detector at each of said positions, and reconstructing a 3D SPECT volume from said scintigraphic exposures.

7. A method as claimed in claim 6 wherein said C-arm system comprises an x-ray source mounted to said C-arm opposite said planar image detector, and comprising moving said C-arm around said subject while irradiating the subject with x-rays emitted by said x-ray source at a plurality of different directions, and acquiring a plurality of x-ray exposures with said planar image detector respectively at said different directions, reconstructing a 3D x-ray volume of the subject from said x-ray exposures, and fusing said 3D x-ray volume with said 3D SPECT volume.

8. An imaging system comprising:
an x-ray system having an x-ray source and a planar image detector operable to detect x-rays emitted from said x-ray source and generate x-ray image data therefrom, said x-ray system being adapted to receive a subject between said x-ray source and said planar image detector;
a gamma radiation parallel collimator disposed substantially immediately in front of said planar image detector, said planar image detector also being operable to detect gamma quanta emitted from the subject after the subject has a gamma quanta-emitting contrast agent administered thereto, that pass through said parallel collimator and are incident on said planar image detector.

9. An imaging system as claimed in claim 8 wherein said planar image detector comprises a scintillator layer of cesium iodide.

10. An imaging system as claimed in claim 8 wherein said x-ray system is a 3D C-arm x-ray system.

11. An imaging system as claimed in claim 8 comprising a frame in which said gamma quanta parallel collimator is removably mounted, allowing removal of said gamma quanta parallel collimator from in front of said planar image detector for detection of x-rays from said x-ray source by said planar image detector.
